(19) United States
(12) Patent Application Publication
(10) Pub. No.: US 2014/0331502 A1
(43) Pub. Date: Nov. 13, 2014

(54) SPLIT FUNNEL HEAD STRAWBERRY LEAF STEM CORE EXTRACTOR TOOL

(71) Applicant: Larry D. Wiertella, Dexter, MI (US)

(72) Inventor: Larry D. Wiertella, Dexter, MI (US)

(21) Appl. No.: 13/889,610

(22) Filed: May 8, 2013

(51) Int. Cl. A47J 25/00

(52) U.S. Cl. CPC A47J 25/00
USPC 30/113.1

(57) ABSTRACT

A one piece tool for removing the leaves, stem and core from different sizes and shapes of strawberries. The handle portion is comprised of grooved straight arms connected by a resilient hinge bend for ease of cleaning. The modified composite split funnel head portion with cutters and stopper ears, pierces the fruit and prevents palatable fruit flesh from being extracted.

### REFERENCES CITED

U.S. PATENT DOCUMENTS

| 0,271,321 A1 | November 2008 | Brunner et al. |
|---|---|---|
| 7,114,258 B2 | October 2006 | Miller |
| 6,032,368 | March 2000 | Huang et al. |
| 5,794,344 | August 1998 | Poulos et al. |
| 5,092,043 | March 1992 | Shirkey |
| 4,949,459 | August 1990 | Noble |
| 2,376,135 | May 1945 | Frasher |

### BACKGROUND OF THE INVENTION

The present invention relates to tools for removing a strawberry's leaf, stem and core. These tools are generally used in restaurant kitchens and bars, residential kitchens and for industrial food handling applications. Such tools are intended to fill the need for removing strawberry leaves, stems and cores at a fast rate and at high volume.

Previous tool applications penetrate the strawberry from its bottom, requiring guesswork for centering, piercing and removing leaf, stem and core, or they pinch the leaf and stem from its top. Those tools that penetrate from the bottom waste more palatable strawberry flesh than necessary. And those that pinch from the top are often ineffective, failing to pull the core from the strawberry. Additionally, previous tools were unable to perform proficient removal on different sized strawberries or irregularly shaped strawberries such as double hybrids. Further, previous strawberry tools were overly complex and hard to clean.

Accordingly, the present invention addresses the need for an easy to use, easy to clean, fast and proficient strawberry leaf, stem and core removal tool that can accommodate strawberries of any shape or size.

### BRIEF SUMMARY OF THE INVENTION

The aforementioned needs for a better strawberry leaf, stem and core removal tool are met by the present invention which pierces from the top of the strawberry and pulls the core out guided by the leaf stem while leaving the strawberry intact without marring or destroying the appearance of the strawberry and provides an appetizing addition to be stuffed, sliced or enjoyed as is. The tool is simple to operate and handle. The tool has built-in stopping notches that prevent user from removing strawberry flesh, by penetrating only to the bottom of the core.

The hinge bend nestles comfortably at the base of the user's index and middle finger, leaving the ends of the fingers and thumb free to align with and close on tool's arms and split head. The user holds the strawberry opposite the hand holding the tool. The sharpened head then penetrates the strawberry at the base of the leaf with relatively little force, with the split funnel head grabbing around the leaf, stem and core. The user then pushes the tool down to the stop-notches, twists the tool slightly, either clockwise or counter clockwise, and then with firm pressure withdraws the tool with core and leaf/stem system inside it.

### BRIEF DESCRIPTION OF SEVERAL VIEWS OF THE DRAWING

FIG. 1 is a perspective view of the present invention known as the split funnel head strawberry leaf stem core extractor tool. The tool is shown, held by one hand in a ready-to-use state, with the opposite hand holding a strawberry, aligned in the correct working position.

FIG. 2 is a plan view showing a blank, non-folded state of the split funnel head strawberry leaf stem core extractor tool known as the “present invention.”

FIG. 3 is an open top elevational view of the formed and folded present invention, showing the position of parts, or embodiments, in relationship to each other.

FIG. 4 is an enlarged open front end elevational view of the present invention, showing identically formed right and left halves of the split funnel head with semi-circular notches and stopper ear embodiments.

FIG. 5 is a closed top elevational view of the present invention, showing composite split funnel tapering head, with conjoined semi-circular stop-notches.

FIG. 6 is an enlarged closed frontal elevational view of the present invention, showing the circular back edge of the composite split funnel head, and the serrated oval distal edge of the split funnel head.

FIG. 7 is an inside left arm sectional view of the present invention, showing one identical arm and the position of its parts in relation to each other, and the placement of a formed axial inner groove on each identical arm of the tool, shown by a shaded area.

FIG. 8 shows enlarged cross-sectional views taken at locations b, c, d and e, indicating the diminishing formed inner axial groove of FIG. 7.

FIG. 9 is an enlarged fragmentary, quarter perspective view of the split funnel head, showing the rotary, spiral and serrated cutting edges of the present invention.

FIG. 10 shows an extracted strawberry core and crown with stem and leaf intact.

### DETAILED DESCRIPTION OF THE INVENTION

As required, detailed embodiments of the present invention are disclosed herein; however, it is to be understood that the disclosed embodiments are merely exemplificative of the invention, which may be embodied in various forms. Therefore, specific structural and functional details disclosed herein are not to be interpreted as limited, but merely as a basis for the claims and as a representative basis for teaching one skilled in the art to variously employ the integrity of the present invention in virtually any appropriate detailed structure.

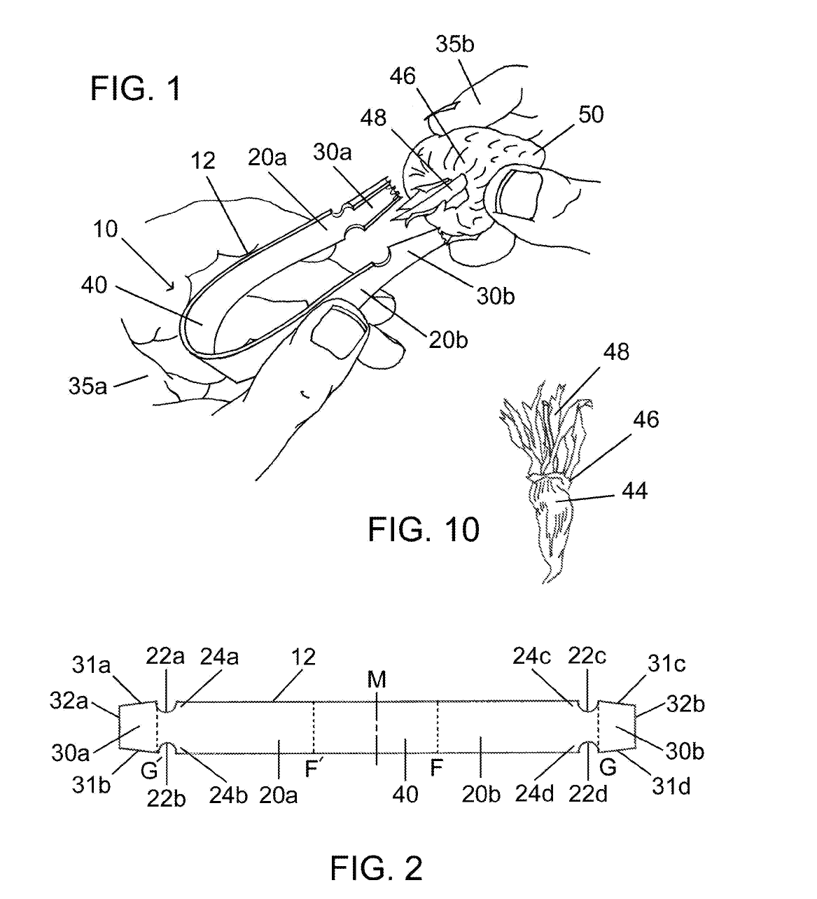

The reference numeral 10 FIG. 1 generally refers to a split funnel head strawberry leaf, stem and core extractor tool in accordance with the present invention as shown in FIGS. 1-10, hereafter referred to as tool 10. Tool 10 is comprised of a handle 12 with a u-shaped resilient hinge bend 40 and two radiating grooved arms 20a, 20b. A composite head 14 FIG. 5, FIG. 6 with split funnel components 30a, 30b of FIG. 5 completes tool 10.

The plan view of tool 10 as seen in FIG. 2 shows a rectangular flat strip of stainless steel, molded plastic, or other suitable material. The handle 12 includes a hinge portion 40 extending from either side of midpoint M to broken lines F′, F where identical straight arms 20a, 20b begin and extend to include semi-circular stop notches 22a,b,c,d, ending at G′,G respectively.

The head portions 30a, 30b begin at broken lines G′, G and include 7 degree tapering sides 31a,b,c,d terminating at distal ends 32a, 32b.

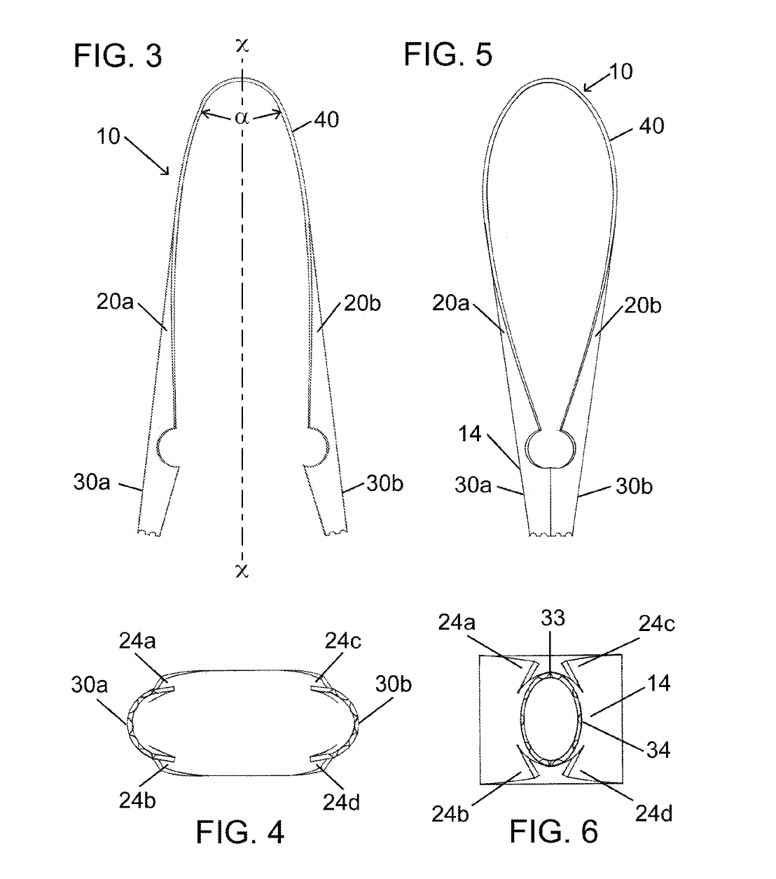

The fabricated elevational view FIG. 3 of tool 10 is symmetrical with respect to a central axis x. An angle α is used to represent the u-shape of hinge bend 40 and opened outwardly extended arms 20a, 20b of handle 12.

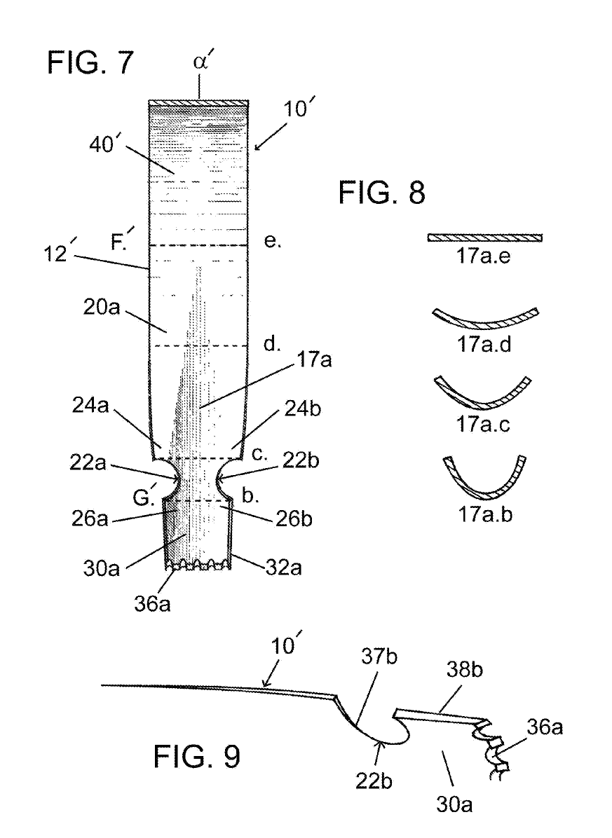

To minimize a lengthy and redundant description of the tool 10 FIG. 1 and use of the embodiments of both arms 20a and 20b, and the head portions, 30a and 30b, the view FIG. 7 of the present invention will be utilized. FIG. 7 is a cross-section view, taken at the central x axis of FIG. 3, showing a one half inside section of tool 10 designated as tool 10′. Because arms 20a and 20b, as well as the head portions 30a and 30b are identical, the embodiments of one arm 20a and one head portion 30a, will be used to give an overview of the composite present invention tool 10, unless otherwise noted.

Referring to FIG. 7, starting at the apex of angle α FIG. 3 of the u-shaped resilient hinge bend 40, the straight arm portion 20a of tool 10′ extends to the back corners of the two opposing semi-circular stop notches 22a, 22b. These two corners, being slightly and inwardly distorted, during the fabrication of the split head 30a, form two stopper ears 24a, 24b. These two stopper ears 24a, 24b serve to limit the depth of the closed composite split funnel head 14 FIG. 5 of the present invention tool 10, when the open head 30a, 30b of FIG. 3 closes around the strawberry's 50, leaves and stem 48, and is caused to penetrate the strawberry's crown 46 FIG. 1.

In the fabrication of the split head portion 30a FIG. 7 of the tool 10′, an axial diminishing groove 17a is formed on the inside of arm 20a, beginning at the front corners G′ of the semi-circular stop notches 22a, 22b, and ending just before the terminating curve of the resilient hinge bend at F′.

The cross-sectional views of arm 20a FIG. 8 at positions b, c, d, and e, shown on FIG. 7, represent the gradual diminishing axial groove 17a of FIG. 7 which, in itself, serves to stabilize the arm 20a from moving side to side or warping, while also strengthening the rigidity of the arm when pressed in use, as seen in FIG. 1. This strengthening groove 17a FIG. 7, which continues toward the curve of the hinge bend at F′, also influences the strength and longevity of the resilient hinge bend 40 and can increase this influence if extended further into the hinge bend at F′.

The head 30a FIG. 7 of tool 10′ begins at G′ on the front corners 26a, 26b of the semi-circular stop notches 22a, 22b as indicated on the cross-sectional view of FIG. 7, and terminates with a pre-filed inside serrated cutting piercing edge 36a FIGS. 7 and 9 at the distal end 32a of tool 10′. This head portion 30a starts with a semi-circular axial bend 17a.b FIG. 8 beginning at G′ which decreasingly runs the length of the split head.

These uniformly semi-circular axial bends found in both half sections 30a,30b of tool 10 allows the measured 7 degree angled sides 31a,b and 31c,d of the half head portions 30a, 30b in the plan view FIG. 2 to butt together and form the decreasing composite funnel effect of 14 FIG. 5, which becomes a composite oval 34 FIG. 6 at tool 10′s distal end. In FIG. 6, the composite circular 33 and oval 34 axial bends working together in the composite split funnel head 14 portion allows tool 10 to accommodate strawberries of varying sizes and shapes.

FIG. 9 is the enlarged fragmentary half perspective view of head 30a FIG. 7, and shows one 38b of the two rotary cutting edges of the head 30a, and also shows one 37b of the two spiral cutting edges of stop notch 22b. Furthermore, these cutting edges 38b and 37b, formed by bending and twisting during the axial bending of the split head 30a, can be sharpened in a knife-edge fashion, if so desired.

In use, FIG. 1, a person holds a strawberry 50 in the fingers of one hand 35b, and the opposite hand 35a loosely holds the handle 12 of tool 10 in palm of hand 35a while the index finger and thumb of hand 35a gather, twist and pinch together the leaves and stem 48, if any, of strawberry 50. Next, the hinge bend end 40 of tool 10 nestles at base of middle and index fingers of hand 35a, leaving thumb and index finger of 35a free to align with and press on both arms 20a, 20b of tool 10 shown in FIG. 1. As described, the hand 35a holding the tool 10, lightly clamps the halves of the split funnel head 30a, 30b around the gathered leaves and stem 48 of strawberry 50 still held by hand 35b. The composite split funnel head 14 FIGS. 6 and 5, is lightly pushed into the crown 46 of strawberry 50 FIG. 1, and around the inside core 44 FIG. 10, until the four composite stopper ears 24a, b, c, d of FIG. 6 come to rest on crown 46 of strawberry 50. While squeezing closed arms 20a,20b of handle 12 of tool 10 and twisting strawberry 50 with fingers of hand 35b around the composite split funnel head 14 inside of strawberry 50, either clock-wise or counter clock-wise, the core's crown, sides and bottom will become detached from strawberry 50 by the composite cutting edges 38a,38b and 37a,37b partially shown in FIG. 9 of the composite split funnel head 14 in FIG. 6.

The leaves and stem 48 and core 44 will be extracted from strawberry 50 as gripping funnel head 14 of tool 10 is removed. Releasing grip on arms 20a, 20b will drop leaves and stem 48 and core 44 intact from tool 10′s open split head 30a, 30b, ready for next strawberry. After removal of the leaves and stem 48 and core 44, the unmarred and undamaged strawberry 50 provides an appetizing addition to the palette to be stuffed, coated, or enjoyed as is presented. To say the least, the split funnel head strawberry leaf stem core extractor tool is simple to operate and effortlessly cleaned.

1. A split funnel head strawberry leaf stem core extractor tool comprising:
a. a formed non-corrosive 24 gauge metal strip having a mid-way point u-bend resulting in a resilient hinge;
b. said hinge connecting two radiating straight identical arms of which each arm bears an axial groove supporting the resiliency and stabilization of said hinge and arms respectively;
c. said hinge which facilitates an open and closing action of said arms and serves as a handle of said tool.

2. The tool according to claim 1 wherein:
a. said arms terminate into two tapering semi-circular axial bent halves with 7 degree sides;
b. said sides, with pressure to said arms, butt together forming two opposing halves and a tapering split funnel;
c. said funnel being called the composite head;
d. said head begins with an inwardly serrated sharpened ovate rim and expands for a short measured distance until two opposite ¼ inch composite holes are met;
e. said holes form four semi-circular notches when tension is released on said arms;
f. said notches consist of an inwardly bent funnel portion, a stopper ear portion, and are connected by a spiral cutting edge;
g. said head using four rotary cutting edges along with said spiral cutting edges separate core from strawberry with stem and leaf intact.

3. The tool of claim 1 removing the leaf, stem and core from strawberries of varying sizes and shapes comprising:
a. the adjusting capabilities of said hinge and arms of claim 1;
b. the adjusting capabilities of said tapering split funnel head of claim 2;
c. the gripping capability of said tapering split funnel head of claim
d. said handle of claim 1 nestles at base of middle and index fingers acting as a pressure point, leaving index finger and thumb to align with and close on both arms of claim 1;
e. said rim of claim 2 which encircles said leaf/stem and with minimal force at said pressure point pierces crown of strawberry, and said stopper ears of claim 2 limit the depth of said head;
f. said arms which turn said head clockwise or counter-clockwise to separate said core from strawberry and with the withdrawal of said arms and removal of said head, said leaf, stem and core is held, urged, and extracted from a plurality of strawberry shapes and sizes;
g. said tension when released as in claim 2, said arms open said split funnel head, and said leaf, stem and core is discarded intact from said head.
h. simplicity of one-piece construction, operation, and opening of split funnel head allows said tool to be effortlessly cleaned, sanitized and dried.
